(19) United States
(12) Patent Application Publication
(10) Pub. No.: US 2018/0165386 A1
(43) Pub. Date: Jun. 14, 2018

(54) CHAINING ANALYTIC MODELS IN TENANT-SPECIFIC SPACE FOR A CLOUD-BASED ARCHITECTURE

(71) Applicant: General Electric Company, Schenectady, NY (US)

(72) Inventors: Segar SOUNDIRAMOURTHY, San Ramon, CA (US); Jeanette BRUNO, San Ramon, CA (US); Tun CHANG, San Ramon, CA (US)

(21) Appl. No.: 15/377,279

(22) Filed: Dec. 13, 2016

(51) Int. Cl. G06F 17/50; H04L 29/08

(52) U.S. Cl. CPC G06F 17/5009; H04L 67/10

(57) ABSTRACT

In some embodiments, a cloud-based services architecture may receive operating data from a set of enterprise system devices. The cloud-based services architecture may include a tenant-specific space and an orchestration run-time execution service to manage creation and execution of a first and a second custom analytic model in the tenant-specific space. Moreover, the first analytic model may be customized to run as a service having: (i) some of the received operational data as an input, and (ii) a result of a first analytics process as an output. The second analytic model may be customized to run as a service having: (i) the output of the first analytic model as an input, and (ii) a result of a second analytics process as an output. According to some embodiments, the input of the second analytic model is received from the first analytic model without leaving the tenant-specific space.

### BACKGROUND

The invention relates generally to cloud-based systems to facilitate enterprise analytics. In particular, embodiments may facilitate enterprise analytics by chaining analytic models in a tenant-specific space for a cloud-based architecture.

An enterprise may collect operating data from a set of enterprise system devices. For example, the enterprise may deploy sensors associated with one or more industrial assets (e.g., wind farm devices, turbine engines, etc.) and collect data as those assets operate. Note that the amount of industrial data that can be collected in this way may be significant in terms of volume, velocity, and/or variety. To help extract insight from the data, the enterprise may employ a “cloud-based” industrial internet platform to facilitate creation of applications to turn real-time operational data into insights. As used herein, a “cloud-based” industrial platform may help connect machines to collect key industrial data and stream the information to the cloud and/or leverage services and development tools to help the enterprise focus on solving problems. In this way, the cloud-based industrial platform may help an enterprise deploy scalable services and end-to-end applications in a secure environment.

A cloud-based services architecture may include an orchestration run-time execution engine and tenant-specific spaces. For example, a tenant-specific space for an enterprise might execute a first analytic model application and a second analytic model application. In some cases, it may be desirable to have the output of one model act as the input to another model. For example, the orchestration run-time execution engine may arrange for operating data to be provided as an input to the first analytic model. After performing logical algorithms on the input, the first analytic model may return an output (from the tenant-specific space) to the orchestration run-time execution engine. The orchestration run-time execution engine may then turn that information around and provide it as an input to the second analytic model in the tenant-specific space. That is, the orchestration run-time execution engine can “chain” the output of the first analytic model to the input of the second analytic model. The second analytic model may then perform operations on the information to generate an output that may be provided to one or more remote client platforms.

Note that such an implementation requires that the output of the first analytic model leave the tenant-specific space and then be returned to the second analytics model by the orchestration run-time execution engine. Such an approach may be inefficient and relatively slow, especially when a substantial amount of data is being processed by the cloud-based services architecture. Thus, it may be desirable to provide systems and methods to automatically facilitate analytic model chaining within a tenant-specific space in an efficient and accurate manner.

### BRIEF DESCRIPTION

Some embodiments are associated with a cloud-based services architecture that receives operating data from a set of enterprise system devices. The cloud-based services architecture may include a tenant-specific space and an orchestration run-time execution service to manage creation and execution of a first and a second custom analytic model in the tenant-specific space. Moreover, the first analytic model may be customized to run as a service having: (i) some of the received operational data as an input, and (ii) a result of a first analytics process as an output. The second analytic model may be customized to run as a service having: (i) the output of the first analytic model as an input, and (ii) a result of a second analytics process as an output. According to some embodiments, the input of the second analytic model is received from the first analytic model without leaving the tenant-specific space.

Some embodiments are associated with: means for receiving, at a cloud-based services architecture, operating data from a set of enterprise system devices; means for managing, by an orchestration run-time execution service of the cloud-based services architecture, creation and execution of a first analytic model and a second custom analytic model in a tenant-specific space, including: means for customizing the first analytic model to run as a service having: (i) at least some of the received operational data as an input, and (ii) a result of a first analytics process as an output, and means for customizing the second analytic model to run as a service having: (i) the output of the first analytic model as an input, and (ii) a result of a second analytics process as an output. According to some embodiments, the input of the second analytic model is received from the output of the first analytic model without leaving the tenant-specific space.

A technical feature of some embodiments is a computer system and method that automatically facilitates analytic model chaining within a tenant-specific space in an efficient and accurate manner.

Other embodiments are associated with systems and/or computer-readable medium storing instructions to perform any of the methods described herein.

### DRAWINGS

FIG. 1 is a high level block diagram of a system.

FIG. 2 is a block diagram of a system to facilitate enterprise analytics according to some embodiments.

FIG. 3 is a flow chart of a method in accordance with some embodiments.

FIG. 4 is an example of a Platform as a Service being provided according to some embodiments.

FIG. 5 is a sample analytics flow in accordance with some embodiments.

FIG. 6 is a block diagram of a cloud-based services architecture to facilitate enterprise analytics according to some embodiments.

FIG. 7 is an apparatus that may be provided in accordance with some embodiments.

FIG. 8 is a tabular view of a portion of an analytic model configuration database in accordance with some embodiments of the present invention.

FIG. 9 illustrates an interactive graphical user display including analytic model customization examples according to some embodiments.

FIG. 10 illustrates an interactive graphical user display including another analytic model customization example in accordance with some embodiments.

FIG. 11 illustrates a tablet computer displaying a analytic model customization example according to some embodiments.

### DETAILED DESCRIPTION

Some embodiments disclosed herein automatically facilitate analytic model chaining within a tenant-specific space in an efficient and accurate manner. Some embodiments are associated with systems and/or computer-readable medium that may help perform such a method.

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

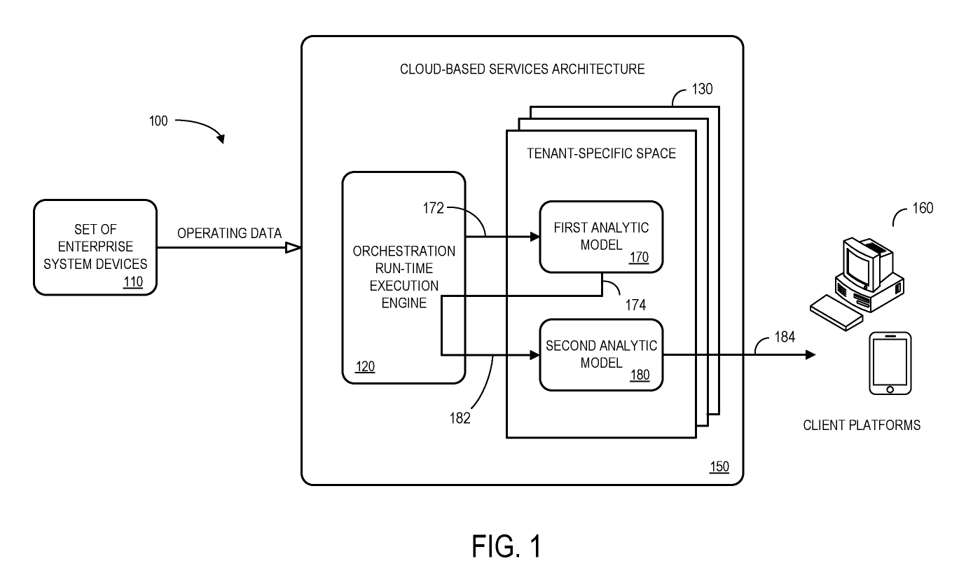

An enterprise may collect operating data from a set of enterprise system devices. For example, the enterprise may deploy sensors associated with one or more industrial assets (e.g., wind farm devices, turbine engines, etc.) and collect data as those assets operate. Moreover, the amount of industrial data that can be collected in this way may be significant in terms of volume, velocity, and/or variety. To help extract insight from the data (and perhaps gain a competitive advantage), the enterprise may employ an industrial internet platform to facilitate creation of applications to turn real-time operational data into insights. FIG. 1 is a high level block diagram of a system 100. In particular, the system includes a set of enterprise system devices 110, such as sensors associated with one or more industrial assets. The enterprise system devices 110 may provide operating data (e.g., an exhaust temperature, a fan speed, etc.) to a cloud-based service architecture 150. The cloud-based services architecture 150 may include an orchestration run-time execution engine 120 and tenant-specific spaces 130. In some embodiments, different tenants may be associated with different enterprises that are utilizing the cloud-based services architecture 150. For example, a tenant-specific space 130 for an enterprise might execute a first analytic model application 170 and a second analytic model application 180. According to some embodiments, an enterprise may “customize” analytic models, such as by defining algorithms, inputs, outputs, etc. to be associated with each model.

In some cases, it may be desirable to have an output of one model act as an input to another model. In the example of FIG. 1, the orchestration run-time execution engine 120 may arrange for operating data to be provided as an input 172 to the first analytic model 170. After performing logical algorithms, operations, etc. on the input 172, the first analytic model 170 may return an output 174 (from the tenant-specific space 130) to the orchestration run-time execution engine 120. The orchestration run-time execution engine 120 may then turn that information around and provide it as an input 182 to the second analytic model 180 (in the tenant-specific space 130). That is, the orchestration run-time execution engine 120 “chains” the output 174 of the first analytic model 170 to the input 182 of the second analytic model. The second analytic model 180 may then perform operations on the information to generate an output 184 that may be provided to one or more remote client platforms 160 (e.g., to facilitate a presentation of an interactive enterprise display to improve the performance of the industrial assets).

Note that such an implementation requires that the output 174 of the first analytic model 170 leave the tenant-specific space 130 and then be returned to the second analytics model 180 by the orchestration run-time execution engine 120. Such an approach may be inefficient and relatively slow, especially when a substantial amount of data is being processed by the cloud-based services architecture 150.

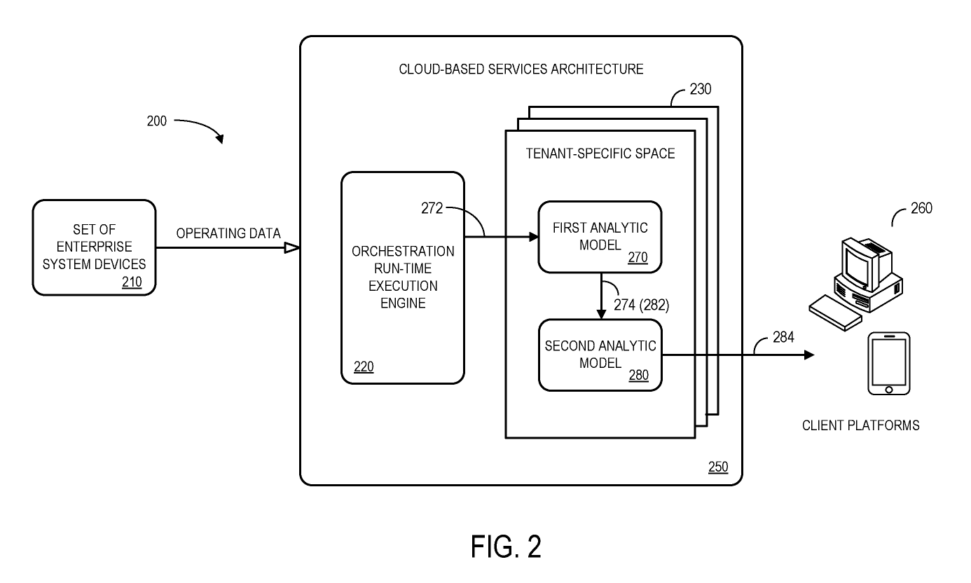

Some embodiments described herein may automatically facilitate analytic model chaining within a tenant-specific space in an efficient and accurate manner. For example, FIG. 2 is a block diagram of a system 200 that may be associated with any of the embodiments described herein. As before, the system 200 includes a set of enterprise system devices 210, such as sensors associated with one or more industrial assets. The enterprise system devices 210 may provide operating data (e.g., an amount of vibration, an output power level, etc.) to a cloud-based service architecture 250. The cloud-based services architecture 250 may include an orchestration run-time execution engine 220 and “tenant” specific spaces 230. In some embodiments, different “tenants” may be associated with different enterprises that are utilizing the cloud-based services architecture 250. As used herein, the term “tenant” may refer to, for example, a collection of users that share common access to an instance of a software application, resource, and/or the like. In some cases, a tenant may refer to a representation or instance of an organization or enterprise that has access to a multi-tenant application. A tenant may also refer to an application from among a plurality of applications competing for shared underlying resources. The multiple tenants may be logically isolated but physically integrated. For example, the degree of logical isolation may be complete isolation while the degree of physical integration may vary. When devices and services (i.e., edges) communicate with applications in the cloud, a message oriented middleware may be required to handle the complexity of routing communications to and from the cloud, while maintaining isolation between different tenants.

With a multi-tenant architecture, a software application may be designed to provide each tenant-specific space 230 a dedicated share of the instance including its data, configuration, user management, tenant individual functionality and non-functional properties. For example, a tenant-specific space 230 for an enterprise might execute a first analytic model application 270 and a second analytic model application 280. According to some embodiments, an enterprise may “customize” analytic models, such as by defining algorithms, inputs, outputs, etc. to be associated with each model.

Note that in some cases, it may be desirable to have an output of one model act as an input to another model. In the example of FIG. 2, the orchestration run-time execution engine 220 may arrange for operating data to be provided as an input 272 to the first analytic model 270. After performing logical algorithms, operations, etc. on the input 272, the first analytic model 270 may generate an output 274 that is provided directly to the second analytic model 180 as an input 282 (without exiting the tenant-specific space 230). The second analytic model 280 may then perform operations on the information to generate an output 284 that is provided to one or more remote client platforms 260 (e.g., to facilitate a presentation of an interactive enterprise display to improve the performance of the industrial assets).

Note that operating data may be associated with a “big data” stream that is received by the cloud-based services architecture 250 on a periodic or asynchronous basis. Moreover, the client platforms 260 may, for example, be used to execute a web browser, smartphone application, etc. to provide results from and/or facilitate understating of the big data. As used herein, the phrase “big data” may refer to data sets so large and/or complex that traditional data processing applications may be inadequate (e.g., to perform appropriate analysis, capture, data curation, search, sharing, storage, transfer, visualization, and/or information privacy for the data). Analysis of big data may lead to new correlations, to spot business trends, prevent diseases, etc. Scientists, business executives, practitioners of media and advertising and governments alike regularly meet difficulties with large data sets in areas including Internet search, finance and business informatics. Scientists encounter limitations in meteorology, genomics, complex physics simulations, biological and environmental research, etc.

Any of the devices described with respect to the system 200 might be, for example, associated with a Personal Computer (“PC”), laptop computer, smartphone, an enterprise server, a server farm, and/or a database or similar storage devices. According to some embodiments, an “automated” cloud-based services architecture 250 may facilitate the collection and analysis of big data. As used herein, the term “automated” may refer to, for example, actions that can be performed with little (or no) intervention by a human.

As used herein, devices, including those associated with the cloud-based services architecture 250 and any other device described herein may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Although a single cloud-based services architecture 250 is shown in FIG. 2, any number of such devices may be included. Moreover, various devices described herein might be combined according to embodiments of the present invention. For example, in some embodiments, the cloud-based services architecture 250 and orchestration run-time execution engine 220 might be co-located and/or may comprise a single apparatus.

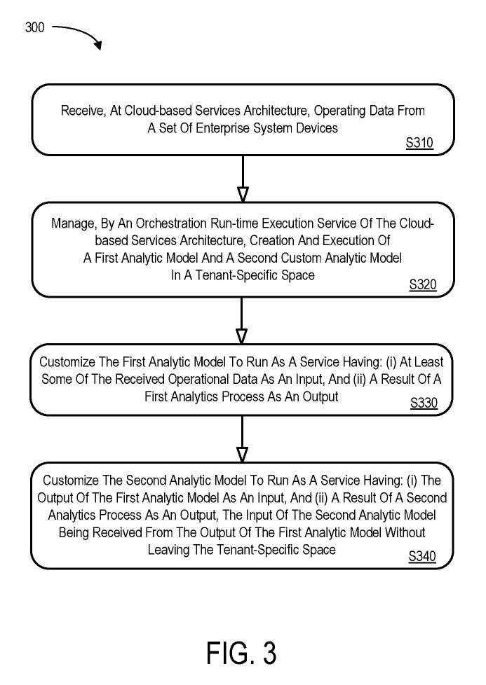

Note that the system 200 of FIG. 2 is provided only as an example, and embodiments may be associated with additional elements or components. According to some embodiments, the elements of the system 200 automatically facilitate analytic model chaining within a tenant-specific space in an efficient and accurate manner. Consider, for example, FIG. 3 which is a flow chart of a method 300 associated with a method in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S310, a cloud-based services architecture may receive operating data from a set of enterprise system devices. The set of enterprise system devices might be, for example, associated with one or more of: sensors, a big data stream, an industrial asset, a power plant, a wind farm, a turbine, power distribution, fuel extraction, healthcare, transportation, aviation, manufacturing, and/or water processing. Moreover, according to some embodiments, the cloud-based services architecture is further associated with edge software to enable secure connectivity and communication between devices of the enterprise. The cloud-based services architecture may also provide data management to coordinate services for efficient data storage and modeling. In some embodiments, the cloud-based services architecture may also provide security to establish clear authorization and/or authentication for application. Still other embodiments may facilitate the building, testing, and/or deployment of applications and services, including those provided via mobile applications.

At S320, an orchestration run-time execution service of the cloud-based services architecture may manage creation and execution of a first “analytic model” and a second custom “analytic model” in a tenant-specific space. As used herein, the phrase “analytic model” may refer to, for example, a model that runs key complex analysis algorithms on significant data sets. According to some embodiments, the tenant-specific space uses a service broker architecture and interface for individual service level tenancy while providing a mechanism to provision tenant-specific service instances and a registry mapping tenant to service instances.

At S330, the service may customize the first analytic model to run as a service having: (i) at least some of the received operational data as an input, and (ii) a result of a first analytics process as an output. At S340, the service may customize the second analytic model to run as a service having: (i) the output of the first analytic model as an input, and (ii) a result of a second analytics process as an output. Note that that the input of the second analytic model may be received from the output of the first analytic model without leaving the tenant-specific space. According to some embodiments, the output of the second analytic model is to be provided to an asset service, a time-series service, and/or a Relational DataBase Management System (“RDBMS”). Moreover, a relationship between the first analytics service and the second analytics service might be associated with a sequence flow, a conditional flow, a custom data connector, a model library, and/or an analytic message queue.

According to some embodiments, a workflow engine of the orchestration run-time execution service arranges for the output from the first analytic model is provided as inputs to a plurality of other analytic models running as services in the tenant-specific space. Similarly, a workflow engine of the orchestration run-time execution service might arrange for outputs from a plurality of other analytic models running as services in the tenant-specific space are provided into the first analytic model as inputs.

According to some embodiments, the output of the first analytic model is stored into a cache within the tenant-specific space before being provided as the input of the second analytic model. The cache might comprise, for example, an in-memory cache of the tenant-specific space. Because this process is performed entirely “in memory” inside the tenant-specific space, execution of the models may be efficient and relatively fast.

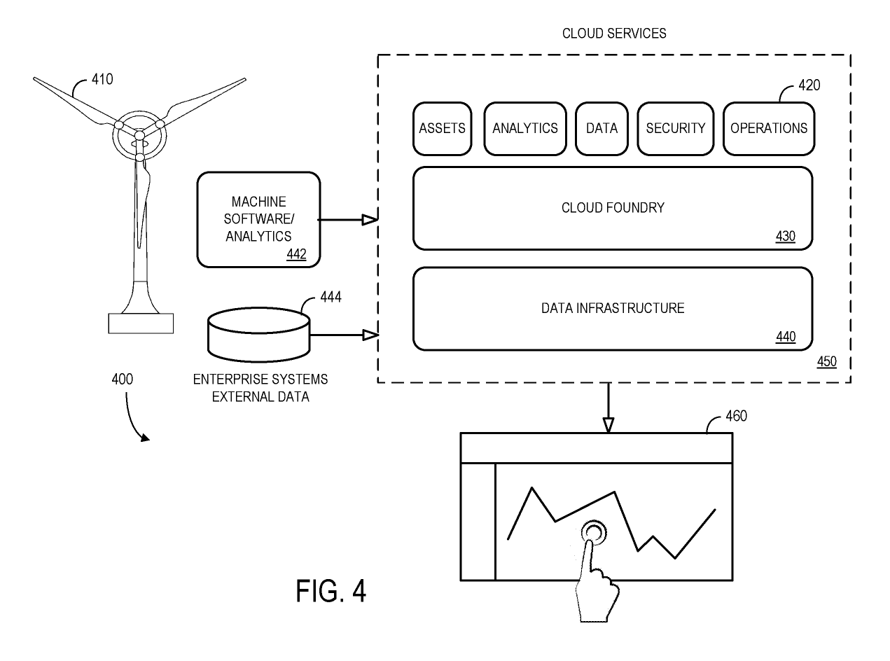

FIG. 4 is an example 400 of a Platform as a Service (“PaaS”) being provided according to some embodiments. The example 400 includes an industrial asset 410 associated with machine software/analytics 442 and enterprise system external data 44 that provide information to cloud services 450. The cloud services 450 include a cloud foundry 430 associated with specific functionality 420 and data infrastructure 440. The functionality 420 might include, for example, assets (e.g., associated with specific industrial equipment), analytics (e.g., to run key complex analysis algorithms on important data assets), data (e.g., to coordinate services for efficient data storage and/or modeling), security (e.g., to establish clear authorization and/or authentication for application), and/or operations (e.g., to manage building, testing, and/or deploying of applications and services).

The cloud services 450 may, for example, facilitate the presentation of interactive displays 460 (e.g., mobile display) to a user in accordance with any of the embodiments described herein. For example the cloud services 450 may automatically facilitate analytic model chaining within a tenant-specific space in an efficient and accurate manner. In this way, the system may comprise a machine-centric solution that supports heterogeneous data acquisition, storage, management, integration, and access. Moreover, the system may provide advanced predictive analytics and guide users with intuitive interfaces that are delivered securely in the cloud. In this way, users may rapidly build, securely deploy, and effectively operation industrial applications in connection with the industrial Internet of Things (“IoT”).

Note that a cloud services 450 platform may offer a standardized way to enable an enterprise to quickly take advantage of operational and business innovations. By using the platform which is designed around a re-usable building block approach, developers can build applications quickly, leverage customized work, reduce errors, develop and share best practices, lower any risk of cost and/or time overruns, and/or future-proof initial investments. Moreover, independent third parties may build applications and services for the platform, allowing businesses to extend capabilities easily by tapping an industrial ecosystem. In this way, the platform may drive insights that transform and/or improve Asset Performance Management (“APM”), operations, and/or business.

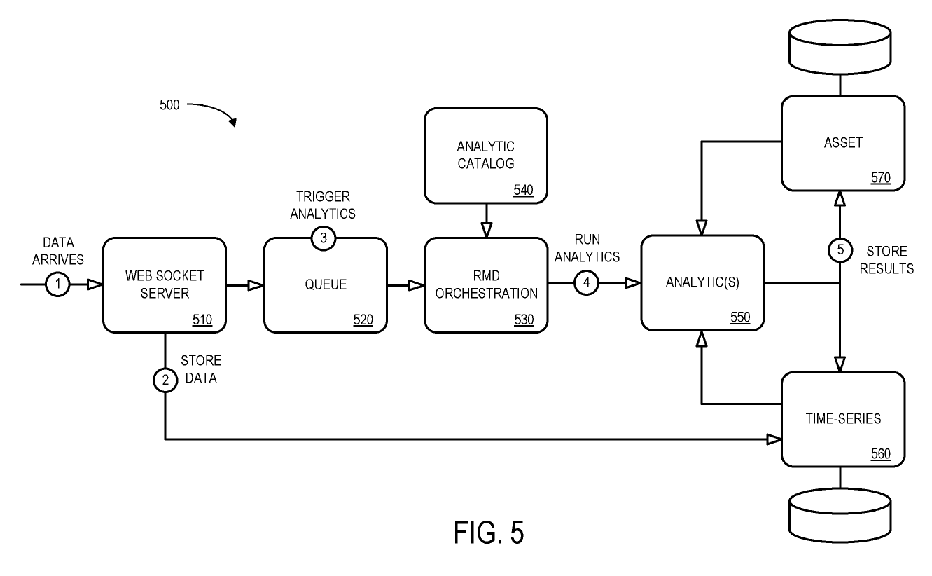

FIG. 5 is a sample analytics flow 500 in accordance with some embodiments. At (1), data may arrive at a web socket server 510. The data may stored at (2) into a time-series 560. At (3), queue-based trigger analytics 520 may be performed and provided to Remote Monitoring and Diagnosis (“RMD”) orchestration 530. The RMD orchestration 530 may utilize an analytic catalog 540 and provide run analytics to an analytics element 550 at (4). Note that the analytics element 550 may operate in accordance with any of the embodiments described herein. For example, the analytics element 550 (and/or other portions of the flow 500) may automatically facilitate analytic model chaining within a tenant-specific space in an efficient and accurate manner. The results from the analytics element 550 may be stored in an asset service 570 and/or the time-series service 560 at (5). Such an embodiment, for example, may handle data as it arrives (or changes) by placing an event on a messaging topic. A project may then read messages off of those queues, decide which analytic orchestrations to invoke, obtain the appropriate Business Process Model and Notation (“BPMN”) data and analytic configuration and pass that to the orchestration engine (which may in turn invoke analytic microservices in accordance with any of the embodiments described herein).

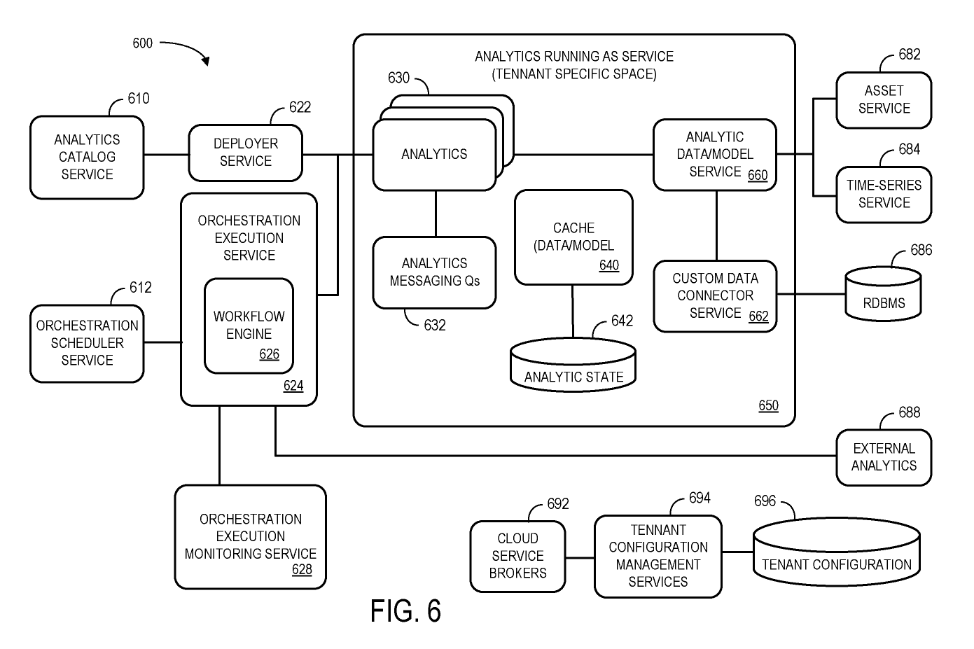

FIG. 6 is a block diagram of a cloud-based services architecture 600 to facilitate enterprise analytics according to some embodiments. As illustrated in FIG. 5, an orchestration execution service 624 may interact with analytics running as a service 650 in a tenant-specific space. Moreover, a deployer service 622 may access an analytics catalog service 610 (and a workflow engine 626 of the orchestration execution service 624 may access an orchestration schedule service 612) to deploy analytics 630 in the analytics running as a service 650. The orchestration execution service 624 may also store information into an orchestration execution monitoring service 628 (e.g., via monitoring messaging) and external analytics 688. Note that the analytics running as a service 560 may automatically facilitate analytic model chaining within the tenant-specific space in an efficient and accurate manner in accordance with any of the embodiments described herein.

The analytics 630 may interact with analytic message queues 632, an analytic data/model service 660, and/or a cache 640 for data or a model (e.g., via get/put operations). The analytic data/model service 660 may provide results to an asset service 682 and/or a time-series service 684 as well as to an RDBMS 686 via a custom data connector service 662. Note that the cache 640 may store an analytic state 642 and be used to store an output of a first analytic model within the tenant-specific space before being provided as an input of a second analytic model. The cache 640 might comprise, for example, an in-memory cache of the tenant-specific space. Because this process is performed entirely “in memory” inside the tenant-specific space, the cache 640 may help make execution of the models efficient and relatively fast. According to some embodiments, tenant configuration management services 694 may receive information from cloud service brokers 692 and store information into a tenant configuration database 696.

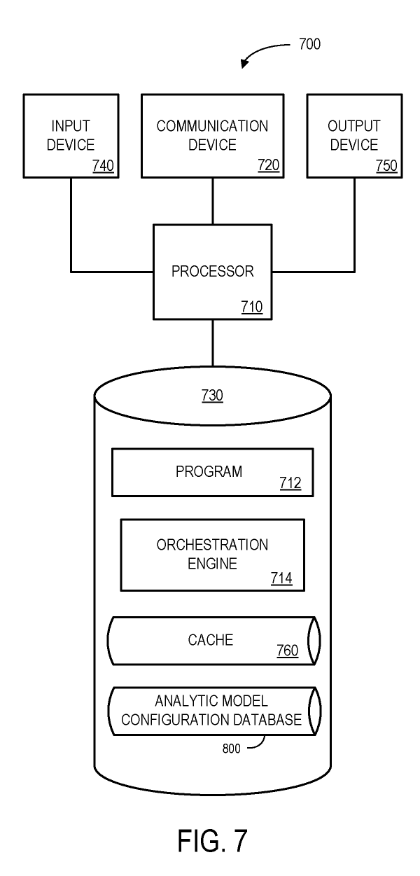

The embodiments described herein may be implemented using any number of different hardware configurations. For example, FIG. 7 illustrates an apparatus 700 that may be, for example, associated with the system 200 of FIG. 2. The apparatus 700 comprises a processor 710, such as one or more commercially available Central Processing Units (CPUs) in the form of one-chip microprocessors, coupled to a communication device 720 configured to communicate via a communication network (not shown in FIG. 7). The apparatus 700 further includes an input device 740 (e.g., a mouse and/or keyboard to enter information about industrial asset operation, user display preferences, etc.) and an output device 750 (e.g., a computer monitor to output interactive visualizations and reports).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or an orchestration engine 714 for controlling the processor 710. The processor 710 performs instructions of the programs 712, 714, and thereby operates in accordance with any of the embodiments described herein. For example, the processor 710 might receive operating data from a set of enterprise system devices. A cloud-based services architecture may include a tenant-specific space and an orchestration run-time execution service to manage creation and execution of a first and a second custom analytic model in the tenant-specific space. Moreover, the first analytic model may be customized via the processor 710 to run as a service having: (i) some of the received operational data as an input, and (ii) a result of a first analytics process as an output. The second analytic model may be customized via the processor 710 to run as a service having: (i) the output of the first analytic model as an input, and (ii) a result of a second analytics process as an output. According to some embodiments, the input of the second analytic model is received from the first analytic model without leaving the tenant-specific space.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the apparatus 700 from another device; or (ii) a software application or module within the apparatus 700 from another software application, module, or any other source.

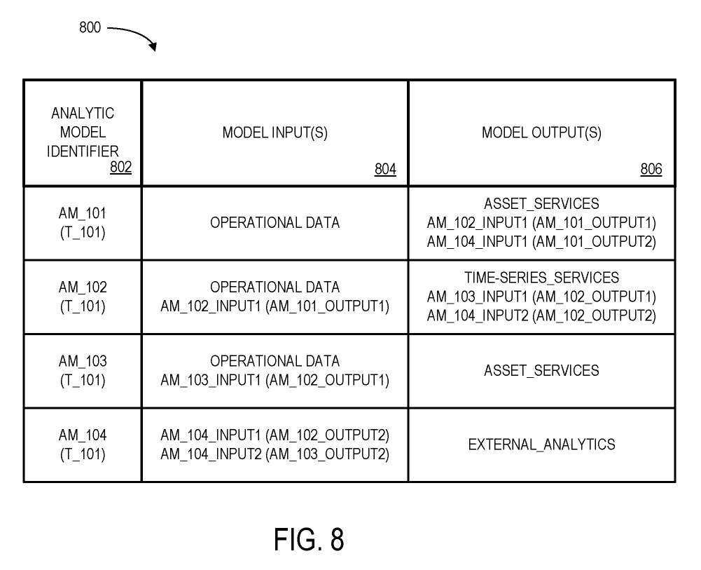

As shown in FIG. 7, the storage device 730 also stores a cache 760 and an analytic model configuration database 800. One example of the analytic model configuration database 800 that may be used in connection with the apparatus 700 will now be described in detail with respect to FIG. 8. The illustration and accompanying descriptions of the database presented herein is exemplary, and any number of other database arrangements could be employed besides those suggested by the figures.

FIG. 8 is a tabular view of a portion of the analytic model configuration database 800 in accordance with some embodiments of the present invention. The table includes entries associated with analytic models that may facilitate management of industrial assets for an enterprise. The table also defines fields 802, 804, 806 for each of the entries. The fields specify: an analytic model identifier 802, model inputs 804, and model outputs 906. The information in the analytic model configuration database 800 may be periodically created and updated based on customization information received from users in connection with the monitoring of an industrial asset's operation.

The analytic model identifier 1002 might be a unique alphanumeric code identifying 1002 an algorithm, process, etc., that might be performed on data. The analytic model identifier 1002 might also identify one or more tenants associated with the model. For example, analytic models “AM_101” through “AM_104” might all be associated with a single tenant (“T_101”) as illustrated in FIG. 8. The model inputs 804 might be used to customize the data that will be received by the analytic model. For example, analytic model “AM_101” will receive operation data as an input as illustrated by the first entry in FIG. 8. The model outputs 806 might be used to customize where the data will be transmitted from or stored by the analytic model. For example, analytic model “AM_102” will send data as an output to “Asset Services” as illustrated by the third entry in FIG. 8. According to some embodiments, the output 806 of one analytic model might be defined as a direct input 804 to another analytic model (without leaving a tenant-specific space). For example, an output 806 of “AM_102” (referred to as “AM_102_Output1” in the table) is also the input 804 of “AM_103” (referred to as “AM_103_Input1” in the table). Such an approach may, for example improve the data processing efficiency of the platform.

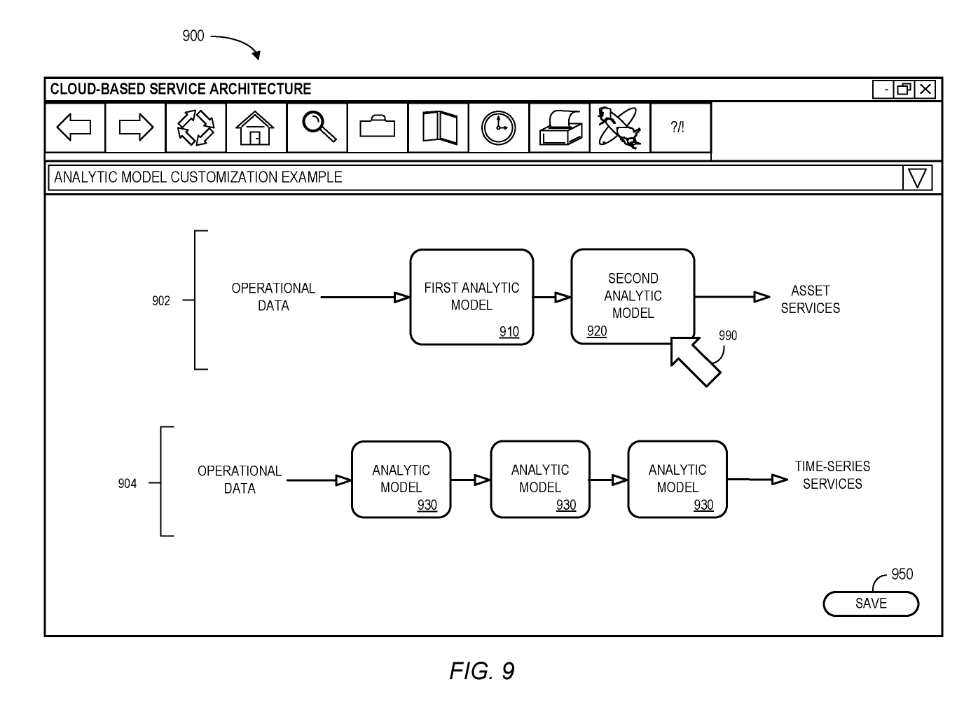

FIG. 9 illustrates an interactive graphical user display 900 including analytic model customization examples 902, 904 according to some embodiments. In the first example 902, a first analytic model 910 receives operational data and provides information directly to a second analytic model 920 (without having the information leave a common tenant-specific space). The second analytic model 920 may process the received information and provide a result to asset services. According to some embodiments, a computer pointer 990 (or a touch screen) may be used to select a graphic data element on the display 900. Selection of a graphical data element on the display 900 might, for example, result in a pop-up window providing further information about the display, allow for customization of the graphical element (e.g., by dragging-and-dropping elements to change inputs and/or outputs), etc. According to some embodiments, selection of a “Save” icon might cause the system to store the user's customizations. Although two analytic models are illustrated in the first example, note that embodiments may be associated with any number of models. For example, as illustrated in the second example 904, three analytic models 930 may be chained together by the user within the tenant-specific space (and the output may be stored into time-series services).

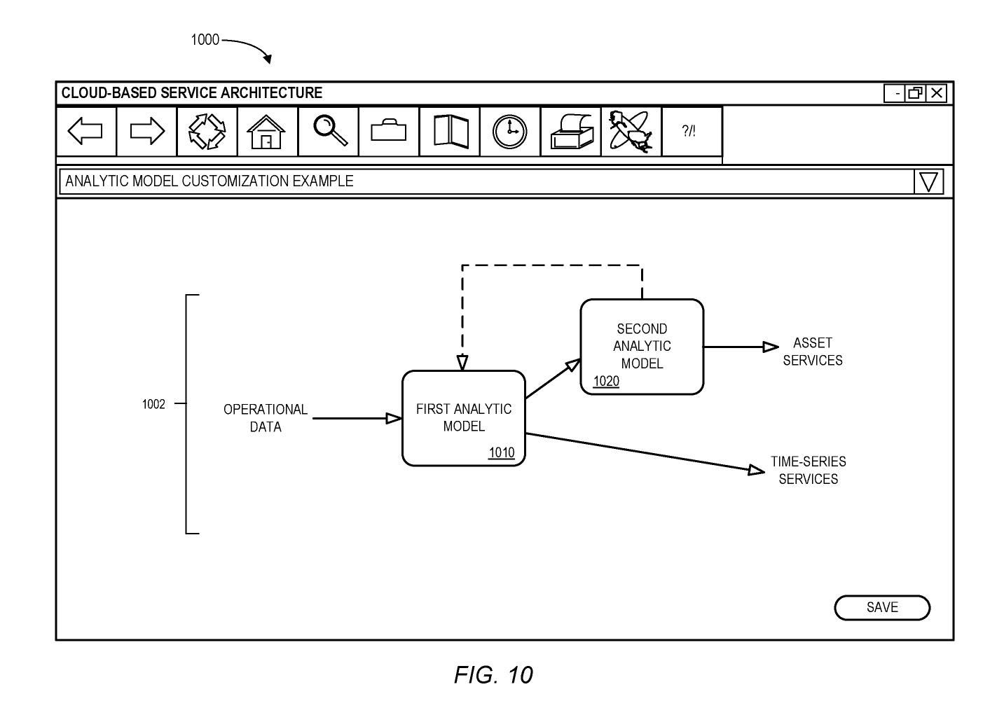

Although the examples 902, 904 of FIG. 9 are chained linearly (with one output corresponding to one input), note that embodiments may be associated with other configurations. For example, a workflow engine of an orchestration run-time execution service might arrange for the output from the first analytic model to be provided as inputs to a plurality of other analytic models running as services in the tenant-specific space and/or to other services. FIG. 10 illustrates an interactive graphical user display 1000 including another analytic model customization example 1002 in accordance with some embodiments. As before, a first analytic model 1010 receives operational data and provides information directly to a second analytic model 1020 (without having the information leave a common tenant-specific space). The second analytic model 1020 may process the received information and provide a result to asset services. According to this embodiment, the first analytic model 1010 might also provide outputs to other analytic models (not illustrated in FIG. 10) and/or other services (e.g., the time-series services). Note that the second analytic model 1020 might also provide an output back to the first analytic model 1010 as an input (e.g., feeding the data back into first analytic model 1010).

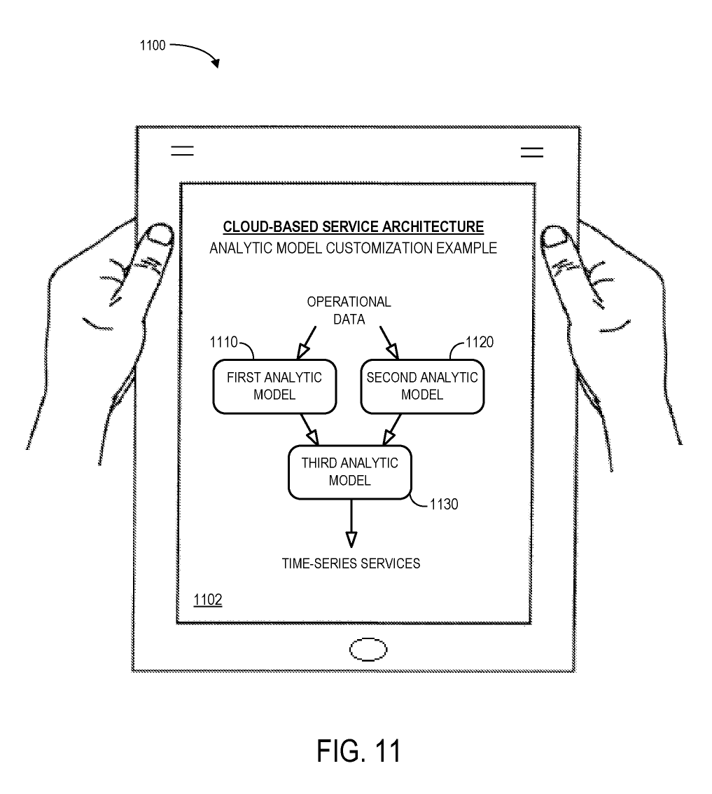

In still other embodiments, a workflow engine of an orchestration run-time execution service might arrange for outputs from a plurality of other analytic models running as services and/or other sources in the tenant-specific space to be provided into an analytic model as inputs. For example, FIG. 11 illustrates a tablet computer 1100 displaying an analytic model customization example 1102 according to some embodiments. In this case, a first analytic model 1010 and a second analytic model 1120 receive operational data and both provide information directly to a third analytic model 1130 (without having the information leave a common tenant-specific space). The third analytic model 1130 may process the received information and provide a result to asset services. Such an approach may, for example improve the data processing efficiency of the platform.

Thus, some embodiments described herein may automatically facilitate analytic model chaining within a tenant-specific space in an efficient and accurate manner. Moreover, such an approach may increase asset utilization with predictive analytics, improving performance and efficiency that can result in lower repair costs. Moreover, embodiments may achieve new levels of performance, reliability, and availability throughout the life cycle of an industrial asset.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems). Applicants have discovered that embodiments described herein may be particularly useful in connection with industrial asset management systems, although embodiments may be used in connection other any other type of asset.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system to facilitate enterprise analytics, comprising:
a set of enterprise system devices to collect and transmit operating data; and
a cloud-based services architecture, to receive the operating data from the set of enterprise system devices, including:
a tenant-specific space, and
an orchestration run-time execution service to manage creation and execution of a first analytic model and a second custom analytic model in the tenant-specific space such that:
the first analytic model is customized to run as a service having: (i) at least some of the received operational data as an input, and (ii) a result of a first analytics process as an output, and
the second analytic model is customized to run as a service having: (i) the output of the first analytic model as an input, and (ii) a result of a second analytics process as an output,
wherein the input of the second analytic model is received from the output of the first analytic model without leaving the tenant-specific space.

2. The system of claim 1, wherein a workflow engine of the orchestration run-time execution service arranges for the output from the first analytic model is provided as inputs to a plurality of other analytic models running as services in the tenant-specific space.

3. The system of claim 1, wherein a workflow engine of the orchestration run-time execution service arranges for outputs from a plurality of other analytic models running as services in the tenant-specific space are provided into the first analytic model as inputs.

4. The system of claim 1, wherein the output of the second analytic model is to be provided to at least one of: (i) an asset service, (ii) a time-series service, and (iii) a relational database management system.

5. The system of claim 1, wherein the output of the first analytic model is stored into a cache within the tenant-specific space before being provided as the input of the second analytic model.

6. The system of claim 5, wherein the cache comprises an in-memory cache of the tenant-specific space.

7. The system of claim 1, wherein a relationship between the first analytics service and the second analytics service is associated with at least one of: (i) a sequence flow, (ii) a conditional flow, (iii) a custom data connector, (iv) a model library, and (v) an analytic message queue.

8. The system of claim 1, wherein the tenant-specific space uses a service broker architecture and interface for individual service level tenancy while providing a mechanism to provision tenant-specific service instances and a registry mapping tenant to service instances.

9. The system of claim 1, wherein the set of enterprise system devices is associated with at least one of: (i) sensors, (ii) a big data stream, (iii) an industrial asset, (iv) a power plant, (v) a wind farm, (vi) a turbine, (vii) power distribution, (viii) fuel extraction, (ix) healthcare, (x) transportation, (xi) aviation, (xii) manufacturing, and (xiii) water processing.

10. The system of claim 1, wherein the cloud-based services architecture is further associated with at least one of: (i) edge software, (ii) data management, (iii) security, (iv) development operations, and (v) mobile applications.

11. A computer-implemented method to facilitate enterprise analytics, comprising:
receiving, at a cloud-based services architecture, operating data from a set of enterprise system devices;
managing, by an orchestration run-time execution service of the cloud-based services architecture, creation and execution of a first analytic model and a second custom analytic model in a tenant-specific space, including:
customizing the first analytic model to run as a service having: (i) at least some of the received operational data as an input, and (ii) a result of a first analytics process as an output, and
customizing the second analytic model to run as a service having: (i) the output of the first analytic model as an input, and (ii) a result of a second analytics process as an output,
wherein the input of the second analytic model is received from the output of the first analytic model without leaving the tenant-specific space.

12. The method of claim 11, wherein a workflow engine of the orchestration run-time execution service arranges for the output from the first analytic model is provided as inputs to a plurality of other analytic models running as services in the tenant-specific space.

13. The method of claim 11, wherein a workflow engine of the orchestration run-time execution service arranges for outputs from a plurality of other analytic models running as services in the tenant-specific space are provided into the first analytic model as inputs.

14. The method of claim 11, wherein the output of the second analytic model is to be provided to at least one of: (i) an asset service, (ii) a time-series service, and (iii) a relational database management system.

15. The method of claim 11, wherein the output of the first analytic model is stored into a cache within the tenant-specific space before being provided as the input of the second analytic model.

16. The method of claim 15, wherein the cache comprises an in-memory cache of the tenant-specific space.

17. A non-transitory, computer-readable medium storing instructions that, when executed by a computer processor, cause the computer processor to perform a method, the method comprising:
receiving, at a cloud-based services architecture, operating data from a set of enterprise system devices;
managing, by an orchestration run-time execution service of the cloud-based services architecture, creation and execution of a first analytic model and a second custom analytic model in a tenant-specific space, including:
customizing the first analytic model to run as a service having: (i) at least some of the received operational data as an input, and (ii) a result of a first analytics process as an output, and
customizing the second analytic model to run as a service having: (i) the output of the first analytic model as an input, and (ii) a result of a second analytics process as an output,
wherein the input of the second analytic model is received from the output of the first analytic model without leaving the tenant-specific space.

18. The medium of claim 17, wherein the output of the first analytic model is stored into an in-memory cache within the tenant-specific space before being provided as the input of the second analytic model.

19. The medium of claim 17, wherein a relationship between the first analytics service and the second analytics service is associated with at least one of: (i) a sequence flow, (ii) a conditional flow, (iii) a custom data connector, (iv) a model library, and (v) an analytic message queue.

20. The medium of claim 17, wherein the tenant-specific space uses a service broker architecture and interface for individual service level tenancy while providing a mechanism to provision tenant-specific service instances and a registry mapping tenant to service instances.

21. The medium of claim 17, wherein the set of enterprise system devices is associated with at least one of: (i) sensors, (ii) a big data stream, (iii) an industrial asset, (iv) a power plant, (v) a wind farm, (vi) a turbine, (vii) power distribution, (viii) fuel extraction, (ix) healthcare, (x) transportation, (xi) aviation, (xii) manufacturing, and (xiii) water processing.

22. The medium of claim 17, wherein the cloud-based services architecture is further associated with at least one of: (i) edge software, (ii) data management, (iii) security, (iv) development operations, and (v) mobile applications.
